(19) United States
(12) Patent Application Publication
(10) Pub. No.: US 2005/0068245 A1
(43) Pub. Date: Mar. 31, 2005

(54) Reflective signal booster for omini-antenna

(76) Inventor: Cheng-Chung Chen, Taipei (TW)

Correspondence Address: SUPREME PATENT SERVICES, POST OFFICE BOX 2339, SARATOGA, CA, 95070, US

(21) Appl. No.: 10/672,542

(22) Filed: Sep. 25, 2003

(51) Int. Cl. H01Q 19/10

(52) U.S. Cl. 343/834; 343/833

(57) ABSTRACT

A reflective signal booster for omni-directional antenna is applicable to a tube or flat omni-directional dipole antenna for changing the antenna from an omni-directional type into a directional type, preventing interference of the radiation of the antenna with other equipments, and improving the antenna gain. The signal booster which can be attached easily to an antenna is composed of a reflector formed by two metal plates forming an included angle that is fixed by an angle fixer. The antenna is supported by a supported member and thus properly located between the metal plates. Thus, electromagnetic waves from the antenna and traveling toward the metal plates is blocked and reflected toward a front opening formed between the metal plates whereby signal intensity in a frontward direction is enhanced and interference with equipments located behind the metal plates is eliminated.

### BACKGROUND OF THE INVENTION

1. Field of the Invention

The present invention relates to radio communication, and it is particularly good for a dipole antenna applied in a wireless LAN base station, a wireless video/audio transmitter/receiver, or a cordless phone.

2. The Prior Arts

A generic omni-directional antenna (including tube or stick antenna) of monopole or dipole type is usually located to connect with a wireless transmitter/receiver device directly and readily interferes with the vicinities.

For dissolving the problem of interference, two conventional ways have been taken:
(1) A high gain directional antenna is adopted to substitute a low gain omni-directional antenna.
(2) A power amplifier, which is generally costly, is added. However, the power amplification causes interferences with other radio equipments and even damage human body health.

The remedy suggested here is to install a signal booster, which is constructed in accordance with the present invention, to the existing monopole or dipole antenna. The signal booster comprises two reflective metal plates that form an included angle for confining electromagnetic waves therein whereby signal is amplified and interference with outer equipment is limited.

### SUMMARY OF THE INVENTION

The present invention provides a reflective signal booster that improves gain, directivity, and interference of an existing antenna.

To realize the abovementioned object, a reflective signal booster constructed in accordance with the present invention comprises two metallic plates forming a predetermined included angle therebetween to serve as a wave reflector, an angle fixer fixing the metal plates and thus maintaining the included angle, and an antenna sleeve that supports and retains the antenna in a predetermined position between the metal plates.

For more detailed information regarding advantages or features of the present invention, at least an example of preferred embodiment will be described below with reference to the annexed drawings, in which:

### BRIEF DESCRIPTION OF THE DRAWINGS

FIG. 1 is a perspective view of a signal booster constructed in accordance with the present invention with a dipole antenna supported therein;

FIG. 2 shows a perspective view of another embodiment of the signal booster in accordance with the present invention;

FIG. 3 is a top view schematically illustrating the operation principle of the signal booster in accordance with the present invention;

FIG. 4-1 shows H-plane pattern of a conventional omni-directional dipole antenna having a gain of 2 dBi;

FIG. 4-2 shows E-plane pattern of the conventional omni-directional dipole antenna having a gain of 2 dBi;

FIG. 4-3 shows H-plane pattern of an omni-directional dipole antenna having a gain of 2 dBi shielded by the signal booster of the present invention;

FIG. 4-4 shows E-plane pattern of the omni-directional dipole antenna having a gain of 2 dBi shielded by the signal booster of the present invention;

FIG. 5-1 shows H-plane pattern of a conventional omni-directional dipole array antenna having a length of 50 cm and a gain of 8.5 dBi;

FIG. 5-2 shows E-plane pattern of the omni-directional dipole array antenna having a length of 50 cm and a gain of 8.5 dBi;

FIG. 5-3 shows H-plane pattern of an omni-directional dipole array antenna having a length of 50 cm and a gain of 2 dBi shielded by the signal booster of the present invention;

FIG. 5-4 shows E-plane pattern of the omni-directional dipole array antenna having a length of 50 cm and a gain of 2 dBi shielded by the signal booster of the present invention;

FIG. 6-1 shows the VSWR curve of a conventional dipole antenna within a range of 2.400-2.484 GHz; and

FIG. 6-2 shows the VSWR curve of a dipole antenna shielded by the signal booster of the present invention within a range of 2.400-2.484 GHz.

### DETAILED DESCRIPTION OF THE PREFERRED EMBODIMENT

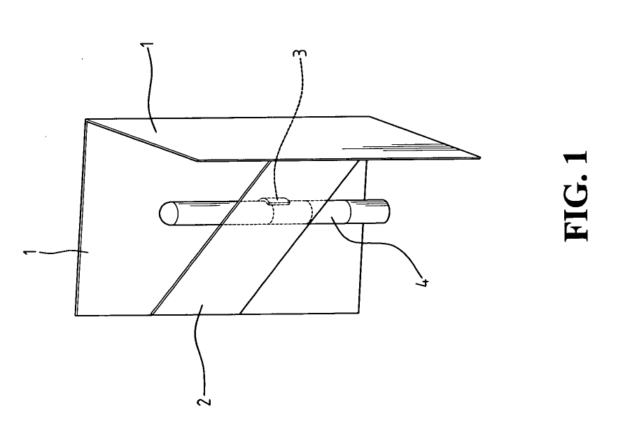

With reference to the drawings and in particular to FIG. 1, a reflective signal booster constructed in accordance with the present invention comprises two metal plates (1) fixed together by an angle fixer (2) to form an included angle within which antenna support sleeve means (3) is fixed for supporting an antenna (4) between the metal plates (1). Preferably, the angle fixer (2) is made of a dielectric material, such as plastics. The metal plates (1) can be any suitable metals, such as copper, aluminum and iron, which form reflective surfaces for electromagnetic waves. The metal plats (1) can be replaced by metal foils attached to a fixture or a metal and plastic laminated structure.

The metal plates (1) are fixed together to form a designated included angle, such as 90 degrees. Alternatively, the signal booster is formed by bending a single sheet of metal plate to form the included angle. The metal plates (1) serve as a wave reflector. The metal plates (1) are fixed together by the angle fixer (2) to maintain the designated included angle.

The antenna support sleeve (3) is made of a dielectric material, such as plastics, and is attached to the metal plates (1). The antenna support sleeve (3) receives and thus fixes the antenna (4) between the metal plates (1). In the embodiment illustrated, the signal booster of the present invention can be employed to enhance the operation and characteristics of for example a monopole antenna, a dipole antenna, and a dipole array antenna, but not limited thereto.

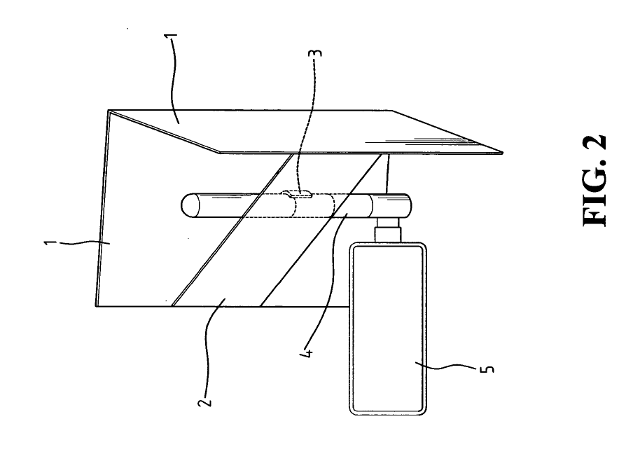

Also referring to FIG. 2, which shows a different alternative of the antenna support sleeve (3), an electronic device (5), such as signal transmitter, is connected to the antenna (4) for transmission of electromagnetic waves.

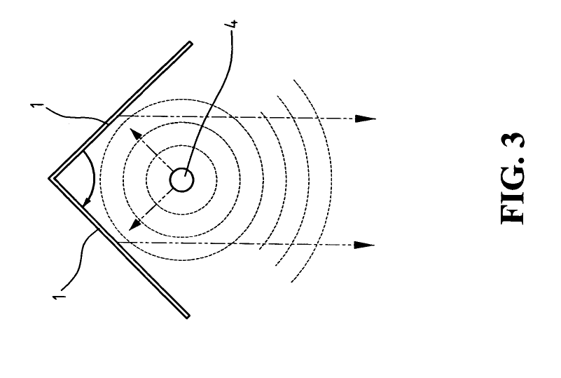

Also referring to FIG. 3, the electromagnetic waves emitted from the antenna (4) is reflected by the metal plates (1) and projected in a direction determined by the orientation of the metal plates (1). Thus, an omni-directional antenna is changed into a unidirectional antenna due to the fact that most of the electromagnetic waves radiated from the omni-directional antenna is reflected by the properly arranged metal plates (1). Consequently, the antenna gain is enhanced and the interference with other equipments is reduced.

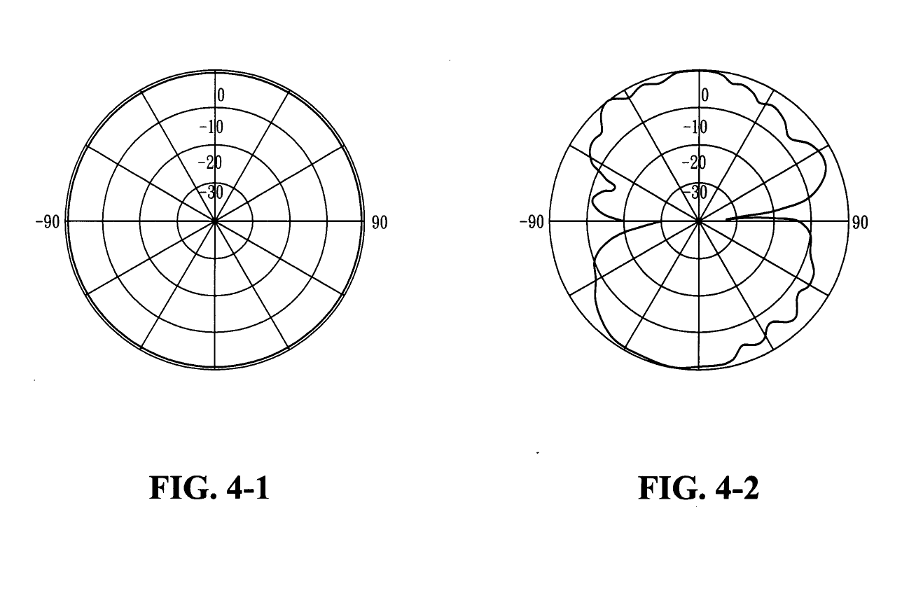

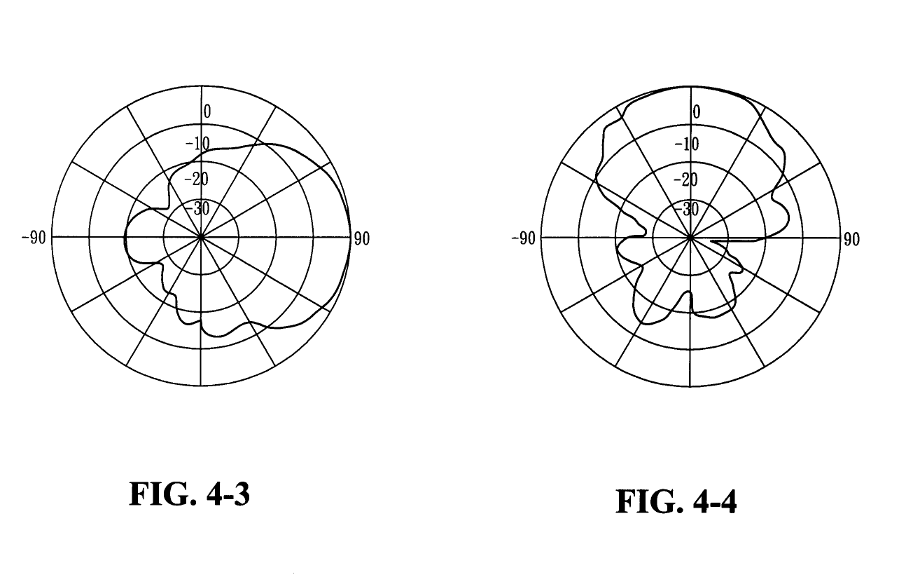

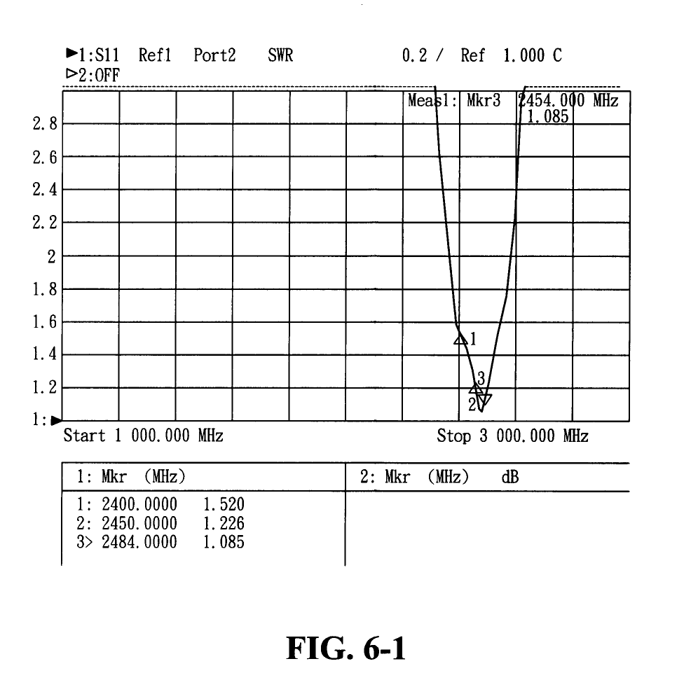

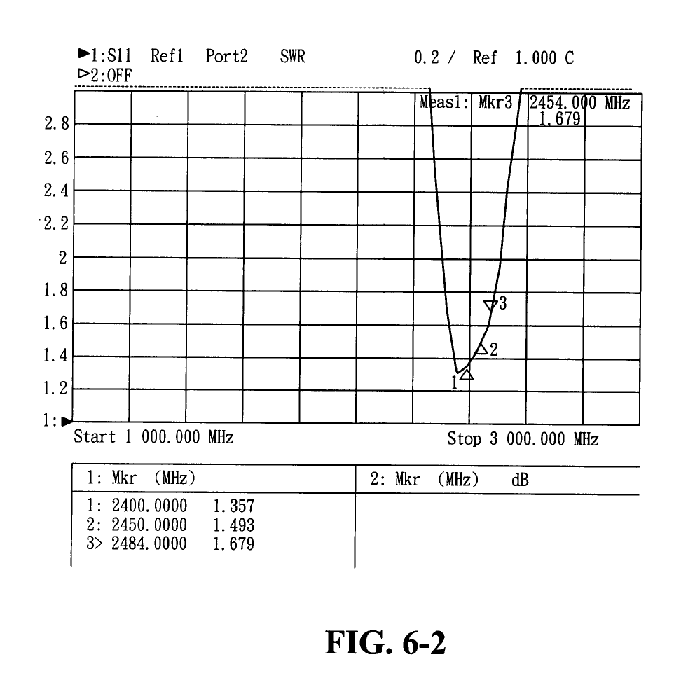

Now, in a first experiment, a signal booster of the present invention is formed with two aluminum plates of 9 cm width and 14 cm height having an included angle of 90° therebetween. An omni-directional dipole antenna is located 5.5 cm distant from the apex of these two metal plates. The omni-directional dipole antenna has a nominal gain of 2 dBi is measured at a frequency of 2.442 GHz in anechoic chamber for both with a signal booster of the present invention and without the signal booster. The measured result of the H-plane and E-plane antenna patterns for the antenna without the signal booster of the present invention is shown in FIGS. 4-1 and 4-2, having a real gain of 1.9 dBi and a VSWR (voltage standing-wave ratio) lower than 2 (as shown in FIG. 6-1 at frequency 2.4-2.5 GHz). The measured result for the omni-directional dipole antenna with the signal booster of the present invention is shown in FIGS. 4-3 and 4-4, respectively for H-plane and E-plane patterns, having a real gain of 8.5 dBi and a VSWR still lower than 2 between frequency 2.4-2.5 GHz (shown in FIG. 6-2) but slightly higher than that antenna without the signal booster.

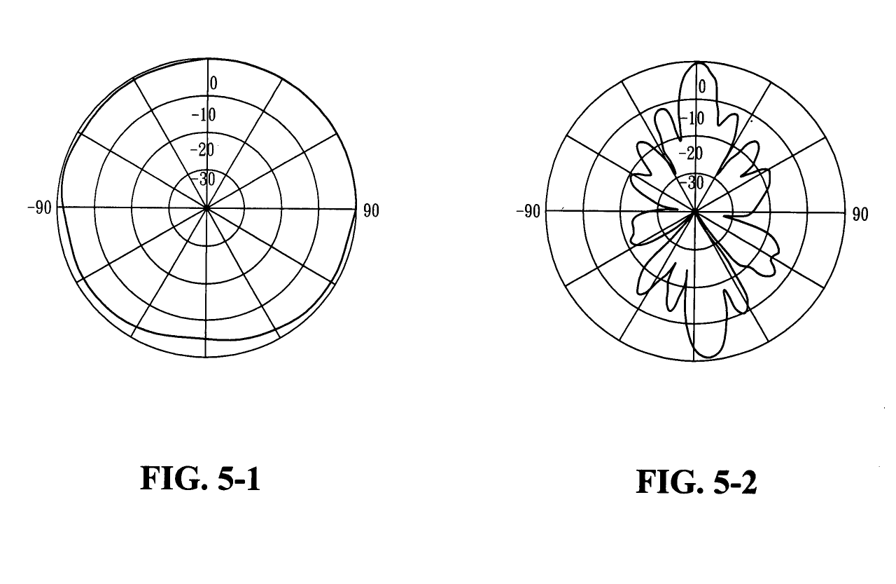

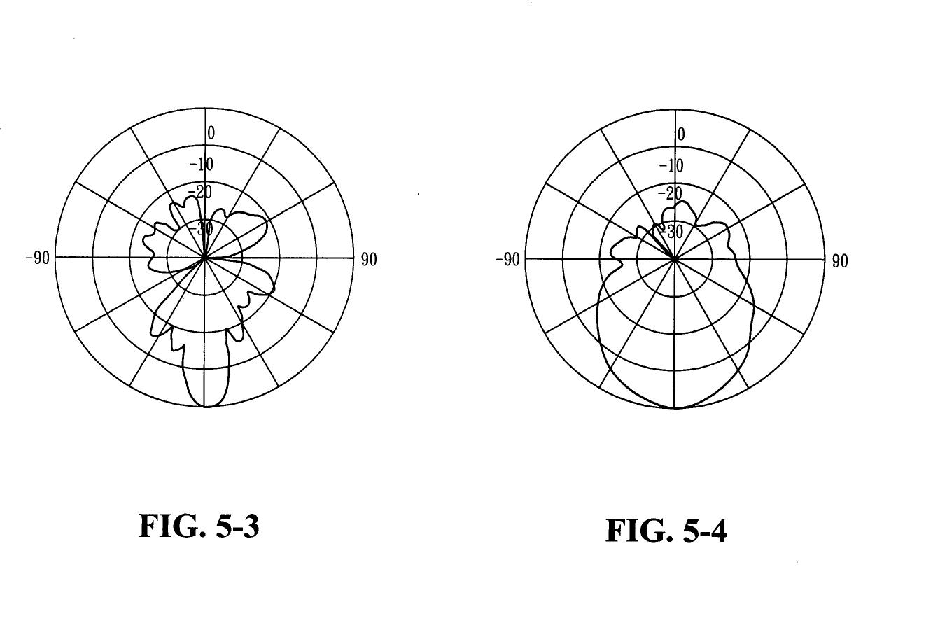

In a second experiment, a signal booster of the present invention is formed with two aluminum plates of 12 cm width and 54 cm height having an included angle of 90° therebetween. An omni-directional dipole array antenna having a length of 50 cm, a diameter of 21 mm and a gain of 8.5 dBi, is located 5.5 cm distant from the apex of metal plates for test. The measured result of the H-plane and E-plane antenna patterns for the antenna without the signal booster of the present invention is shown in FIGS. 5-1 and 5-2, respectively, having a real gain of 8.5 dBi. The measured result for the omni-directional dipole array antenna with the signal booster of the present invention is shown in FIGS. 5-3 and 5-4, respectively for H-plane and E-plane patterns, having a real gain of 14.5 dBi.

According to the signal booster of the present invention, by using just some simple metal and plastic components without modification of the existing antenna and without employing any power amplification devices, it is possible to improve the performance of an omni-directional antenna in the respects of (i) antenna gain and transmission range, (ii) directivity of antenna, and (iii) interference.

In the above described, at least one preferred embodiment has been described in detail with reference to the drawings annexed, and it is apparent that numerous changes or modifications may be made without departing from the true spirit and scope thereof, as set forth in the claims below.

1. A reflective signal booster adapted to incorporate an omni-directional antenna for improving performance of the antenna, the signal booster comprising:
a metallic reflector arranged at a designated angle with respect to the antenna and substantially parallel to the antenna;
an angle fixer made of a dielectric material for fixing the reflector and maintaining the angle of the reflector with respect to the antenna; and
a support sleeve made of a dielectric material supporting the antenna in position.

2. The reflective signal booster according to claim 1, wherein the metallic reflector is made of copper plate.

3. The reflective signal booster according to claim 1, wherein the metallic reflector is made of copper foil.

4. The reflective signal booster according to claim 1, wherein the metallic reflector is made of aluminum plate.

5. The reflective signal booster according to claim 1, wherein the metallic reflector is made of aluminum foil.

6. The reflective signal booster according to claim 1, wherein the metallic reflector is made of iron plate.

7. The reflective signal booster according to claim 1, wherein the metallic reflector is made of plastic-metal laminated films.

8. The reflective signal booster according to claim 1, wherein the metallic reflector comprises two reflective surfaces forming a predetermined angle therebetween with the antenna positioned therebetween by the support.

9. The reflective signal booster according to claim 8, wherein the metallic reflector is made of two metal plates forming the reflective surfaces.
